(19) United States
(12) Patent Application Publication
(10) Pub. No.: US 2008/0067158 A1
(43) Pub. Date: Mar. 20, 2008

(54) LASER-BASED ABLATION METHOD AND OPTICAL SYSTEM

(75) Inventor: Marc LEVESQUE, Saint-Augustin-de-Desmaures (CA)

Correspondence Address: MERCHANT & GOULD PC, P.O. BOX 2903, MINNEAPOLIS, MN, 55402-0903, US

(73) Assignee: Institut National D'Optique, Quebec (CA)

(21) Appl. No.: 11/857,701

(22) Filed: Sep. 19, 2007

(30) Foreign Application Priority Data
Sep. 20, 2006 (CA) 2,560,238

(51) Int. Cl. B23K 26/38

(52) U.S. Cl. 219/121.72; 219/121.67

(57) ABSTRACT

A method and a system for the ablation of volume elements of a target object such as an optical fiber or the like are presented. A CO₂ laser is used to produce a light beam which includes long pulses having a rise time followed by a plateau where the peak power of the laser is attained. The light beam is moved across the target object in such a manner that each of its volume elements is intersected by the light beam during the plateau of a long pulse, so that each volume element is exposed to the peak power of the laser for a short effective pulse.

### FIELD OF THE INVENTION

The present invention relates to the field of micro-machining and more particularly concerns an ablation method and optical system based on a low-cost laser, which can for example be used for cleaving or striping optical fibers.

### BACKGROUND OF THE INVENTION

Laser micro-machining is an advantageous technology for the precision shaping of a variety of small objects, especially for optical fibers and other waveguides or optical components. In the particular case of optical fibers, micro-machining techniques are often required to cleave the fiber (remove an end section) or stripe it (remove a portion of the cladding). CO₂ lasers or the like are often used in this context.

One drawback of laser-based methods for cleaving or striping fibers is that a portion of the laser energy absorbed at the fiber surface is diffused within the fiber through thermal conduction, resulting in a greater volume of material being heated. The volume elements at the surface are vaporised, but a significant amount of the remaining material is transformed into a liquid phase or has a low viscosity which results in deformations in the fiber. Under these conditions, the extremity of the fiber tends to take a rounded form under the effect of surface tensions.

For example, it is known in the art to cleave optical fibers using a laser lathe, in which the fiber is rotated while exposed to a high power laser beam. Systems of this type are shown in U.S. Pat. No. 4,710,605 (PRESBY) and European patents no. EP0391598B1 and EP0558230B1. As mentioned above, one drawback of this approach is that the fiber tends to be overheated, which has the negative effects of rounding the edges of the fiber, causing its end to “flare” , i.e. enlarge its diameter beyond its nominal value, and cause a diffusion of the dopants which define the core of the fiber.

Also known in the art is U.S. patent application no. US 2004/0047587 A1 (OSBORNE). Osborne teaches a cutting method and apparatus for optical fibers and waveguides, using a stationary laser beam. Side and top schematized views of the interaction of the laser beam 22 with the fiber 20 for this technique are respectively shown in FIGS. 1A and 1B (PRIOR ART). The spatial intensity profile of the laser beam is optimized so as to obtain a sharp cutting edge of sufficient intensity to vaporise the matter to be cut through ablation. In order for this method to be efficient, it is required for the laser to have a significantly high peak power, as the laser energy is spread over a relatively large area. As can be seen in FIG. 1B, the laser peak power can be maximized by a good focalisation of the beam in the horizontal plane (in the plane of the page).

U.S. patent application no. US 2005/0284852 A1 (VERGEEST) also teaches of a laser-based technique for cutting optical fibers and the like. In the disclosed method, a laser beam is produced, either in continuous wave or forming very short pulses with steep edges, with sufficient peak energy to ablate matter from an optical fiber or waveguide to be cut. The laser beam and fiber are moved relative to each other to operate the cut. FIGS. 2A and 2B (PRIOR ART) schematically illustrate this method, respectively showing a side view and a top view and the interaction of the laser beam 22 with the fiber 20 for a technique of this type. As with the method of OSBORNE, the beam can be focalised in the horizontal plane to maximise its peak power. However, it is here also focalised in the vertical plane as the beam is moved over the section of the fiber as opposed to being spread over it.

Although the techniques of the two last prior art documents mentioned above may provide good quality cuts where thermal effects are reduced, they both necessitate the use of expensive high power cutting lasers in order to achieve those results. There is therefore a need for a less expensive method and apparatus which allow similar results to be obtained.

### SUMMARY OF THE INVENTION

According to a first aspect of the present invention, there is provided a laser-based method for the ablation of volume elements across a section of a target object. The method includes the following steps of:
a) generating a light beam using a CO₂ laser. The light beam forms long pulses, each having a temporal shape defined by at least a rise time and a plateau following the rise time, the light beam having a generally constant peak power during the plateau;
b) moving the light beam across the section of the target object, this moving being synchronized with the long pulses so that the light beam intersects each volume elements of the section of the target object in synchronization with the plateau of one of the long pulses of the light beam, thereby at least partially ablating these volume elements through exposition to the peak power; and
c) repeating step b) until the ablation is completed.

In accordance with another aspect of the present invention, there is also provided an optical system for the ablation of volume elements across a section of a target object.

The system first includes a CO₂ laser for generating a light beam, this light beam forming long pulses, each having a temporal shape defined by at least a rise time and a plateau following the rise time. The light beam has a generally constant peak power during the plateau. The system further includes moving means for moving the light beam across the section of the target object. There are also provided synchronizing means for synchronizing this moving with the long pulses so that the light beam intersects each volume elements of the section of the target object in synchronization with the plateau of one of the long pulses of the light beam. Thereby, the volume elements are at least partially ablated through exposition to the peak power.

The present invention may advantageously be used to cleave or stripe optical fibers or the like, with minimal thermal effects, while using components of lower cost than for prior art equivalent systems.

Other features and advantages of the present invention will be better understood upon reading of preferred embodiments thereof with reference to the appended drawings.

### BRIEF DESCRIPTION OF THE DRAWINGS

FIGS. 1A and 1B (PRIOR ART) are respectively a side and a top schematic view of the cleaving of an optical fiber using a first prior art method.

FIGS. 2A and 2B (PRIOR ART) are respectively a side and a top schematic view of the cleaving of an optical fiber using a second prior art method.

FIG. 3 is a graph illustrating the relative intensity as a function of time for laser beams defining short and long pulses or in continuous wave mode.

FIG. 4 schematically illustrates the moving of a light beam according to one aspect of the present invention.

FIGS. 5A, 5B and 5C are respectively a side, a top and a front schematic view of the cleaving of an optical fiber using a method according to an embodiment of the present invention.

FIG. 6 is a diagram showing a system according to an embodiment of the invention.

FIGS. 7A, 7B and 7C are schematic representations of variants of rotating mirrors for use in a system according to embodiments of the present invention.

FIG. 8 is a schematic side view illustrating a method for cutting through an optical fiber according to one embodiment of the invention.

FIGS. 9A and 9B are schematic side views of the striping of an optical fiber according to another embodiment of the present invention.

FIG. 10A schematically shows a non-symmetrical spatial profile of the light beam according to one embodiment of the invention; FIG. 10B shows the corresponding local temporal shape of the light beam intersecting each volume element of the optical fiber.

FIGS. 11A and 11B are side and front views, respectively, of a rotating disk bearing a focussing lens according to an embodiment of the invention.

FIGS. 12A and 12B are front views of a rotating disk on which a plurality of lenses is mounted, respectively equidistant from the center of rotation of the disk and at different distances therefrom.

FIG. 13 is a schematic side view illustrating a method for striping an optical fiber according to one embodiment of the invention.

FIGS. 14A and 14B are side and front views, respectively, of a rotating disk bearing a mirror according to an embodiment of the invention.

### DESCRIPTION OF PREFERRED EMBODIMENTS OF THE INVENTION

In accordance with an aspect of the present invention, a CO₂ laser, preferably of the type known as sealed RF-excited waveguide CO₂ lasers, is used for the ablation of volume elements across a section of a target object. Although the present description will refer to the cleaving or striping of optical fibers as examples of applications of the present invention, it will be readily understood by one skilled in the art that the invention could be used in a variety of different contexts such as removing paint or another coating from a small object, removing acrylic from a LED package, making grooves in a glass piece, polishing glass, etc.

CO₂ lasers are advantageous tools for micro-machining applications in consideration of their cost, durability and ease of use. However, one disadvantage of the use of such devices in this context is that in order to attain their maximum available peak power, they require a substantial rise time, of the order of 50 to 100 μs. In addition, it is only possible to benefit from the maximum peak power for a relatively short time, between about 10 μs and 1000 μs.

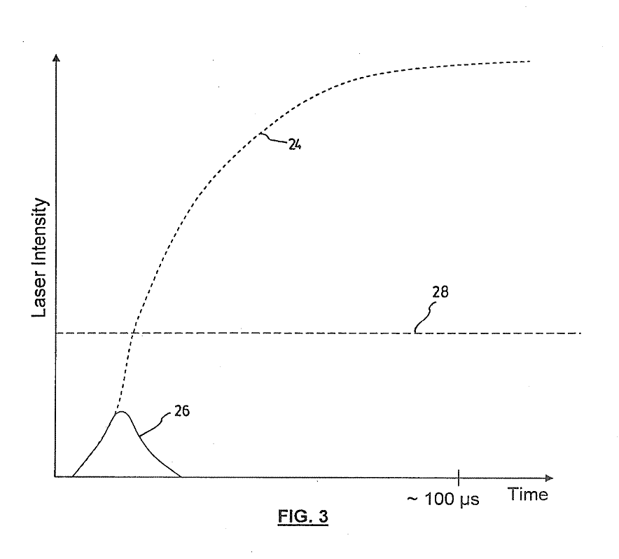

This characteristic of CO₂ lasers is best understood with reference to FIG. 3. As can be seen, to maximize the power of the laser, a long pulse 24 has to be produced with a significant rise time, shown here it to be of about 100 μs. In order to produce a short pulse 26 using the same laser, the rise time has to be cut short, resulting in a much smaller peak power of the short pulse 26 produced. Alternatively, the same laser can be used in CW (Continuous Wave) mode, producing a beam of constant power 28 which is still less than the available peak power.

In the prior art discussed above, such as the OSBORNE and VERGEEST patent applications, it is known to use such lasers either in short pulse or CW mode. Accordingly, the selected lasers need to be powerful enough so that the peak power obtained under such conditions is sufficient to ablate the fiber material while avoiding or limiting heat diffusion. By contrast, the present invention provides a method and apparatus allowing the use of a CO₂ laser in long pulse mode, therefore requiring a less powerful laser to obtain a similar usable peak power. The maximum available power of the laser in long pulse mode can be anywhere between about 25 W and 1000 W.

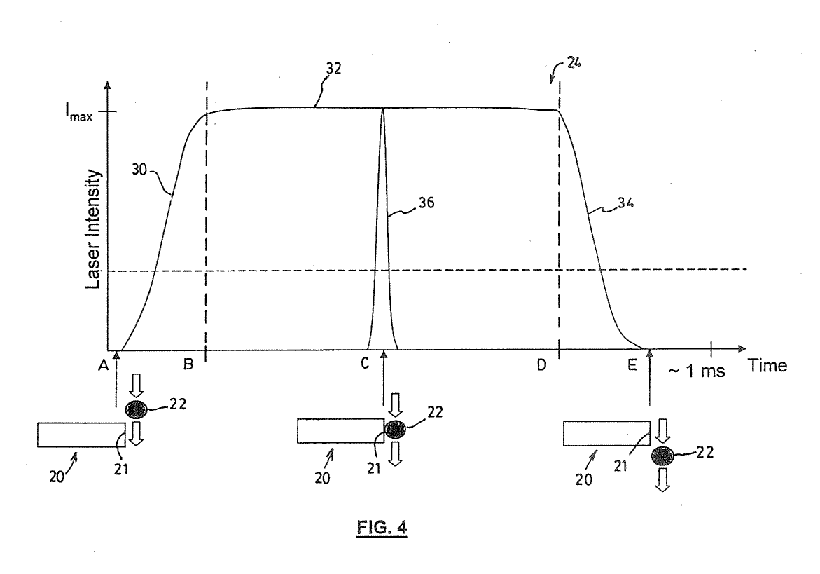

With reference to FIG. 4, the method of the present invention includes a first step of generating a light beam 22 using a CO₂ laser. The light beam 22 forms long pulses 24. In the illustrated embodiment, each long pulse has a substantially rectangular temporal shape defined by a rise time 30, a plateau 32 following the rise time 30, and a fall time 34. It will however be understood by one skilled in the art that the long pulses 24 need not have such a straightforward shape but could include various power variations, as long as their temporal shape includes a significant rise time 30 followed by a plateau 32, the light beam having a generally constant peak power during this plateau. The peak power of the light beam 22 during the plateau 32 preferably corresponds to a maximum available power Iₘₐₓ of the CO₂ laser.

The method then includes a step of moving the light beam 22 across the section of the target object to be ablated, which is embodied by the extremity 21 of an optical fiber 20 in the embodiment of FIG. 4. The moving of the light beam 22 is synchronized with the long pulses 24 so that the light beam 22 intersects each volume element of the optical fiber 20 in synchronization with the plateau of one of the long pulses of the light beam 22. This is best understood by comparing the position of the light beam 22 shown at the bottom of FIG. 4 with the intensity of the long pulse in each case. At point A in time, the rise time 30 of the long pulse 24 begins and the light beam 22 is projected away from the extremity 21 of the fiber 20. It remains so until at least point B where the rise time 30 ends and the plateau 32 begins. Some time during this plateau 32, between points B and D, the light beam 22 makes a passage across the extremity 21 of the fiber 20. This is illustrated at point C. During this passage, each volume element of the extremity of the fiber “sees” a short effective pulse 36 having a peak power equal to that of the long pulse 24, and a pulse width corresponding to the interaction time between the light beam 22 and the corresponding volume element. The peak power is selected to be sufficient to at least partially ablate these volume elements. By the time point D is reached, the light beam 22 is again directed away from the extremity 21 of the fiber 20, and remains so for the entire duration of the fall time 34 and beyond, as illustrated with respect to point E. This step can be repeated with subsequent long pulses until the required ablation is completed.

For a same laser, the above approach provides a power gain of a factor of about 2 to 5 when compared to using the laser in CW mode and of about 3 to 10 in short pulse mode.

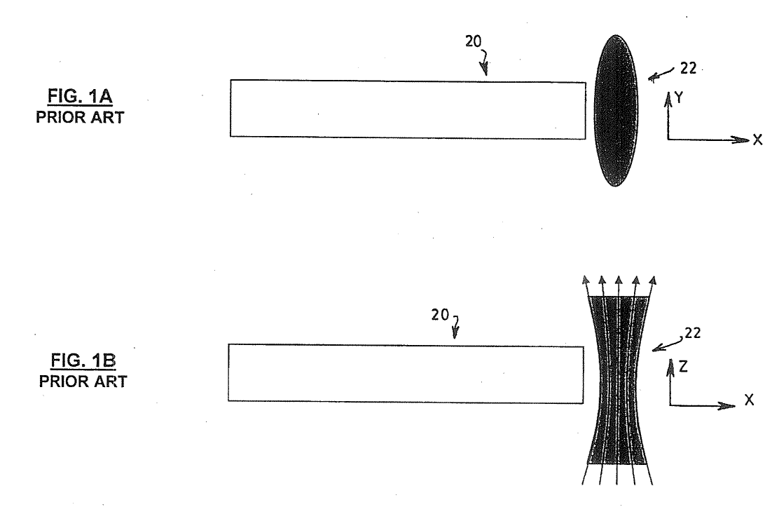

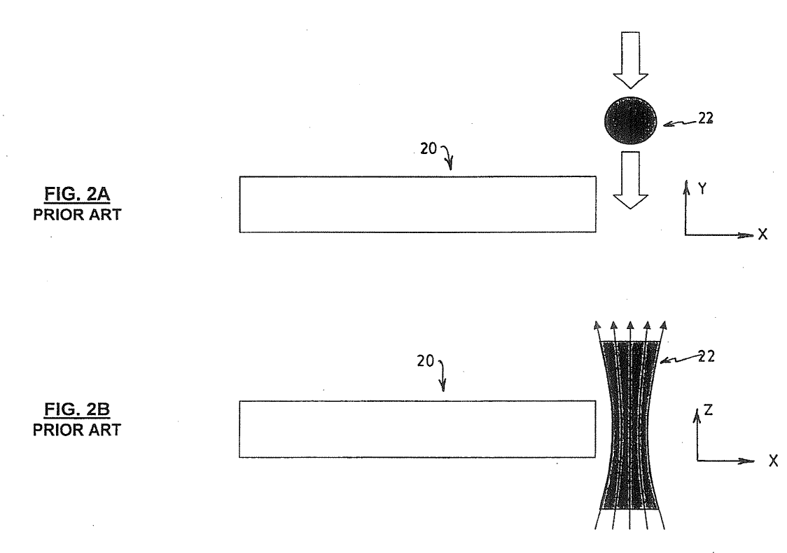

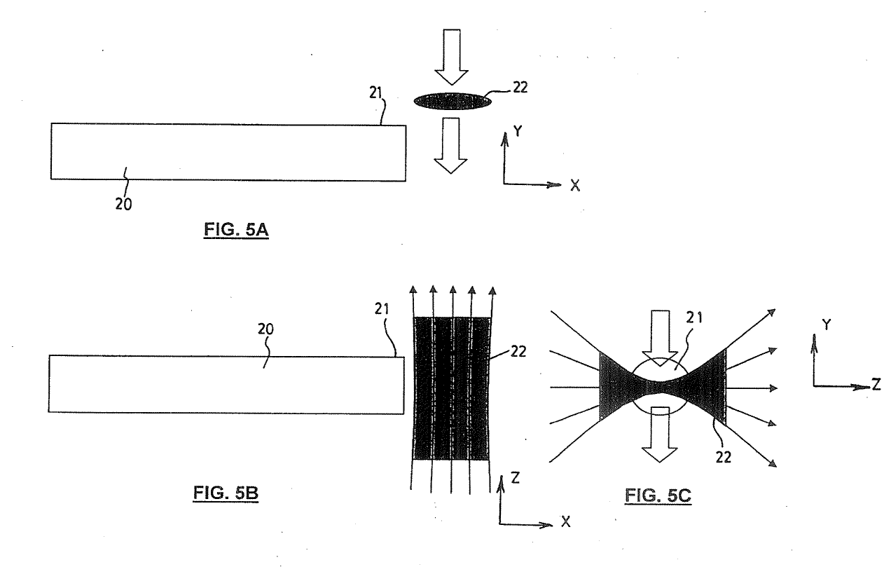

Referring to FIGS. 5A to 5C, a preferred geometry for the light beam 22 used in the method above will now be discussed. To assist in this description, a xyz coordinate system has been provided on FIGS. 1A, 1B, 2A and 2B (all PRIOR ART) as well as on FIGS. 5A to 5C wherein the z axis represents the propagation axis of the light beam 22, and the light beam's cross-section is in an xy plane wherein the x and y axes are respectively perpendicular and parallel to the endmost surface of the extremity 21 of the optical fiber 20. It will of course be understood that this coordinate system is presented for ease of reference only and is in no way considered to be limitative to the scope of the invention.

In the prior art, the cross-section of the light beam used for micro-machining is either circular as in the VERGEEST patent application (see FIG. 2A), or elliptical as in the OSBORNE patent application (see FIG. 1A). OSBORNE uses an elliptically-shaped light beam in order for the beam to be large enough to cover the entire section of the fiber without any relative movement between the two. The elliptical profile of the beam in the OSBORNE application therefore has a short axis perpendicular to the fiber extremity (x axis in FIG. 1A) and a long axis parallel to the fiber extremity (y axis).

In the preferred embodiment of the invention, the light beam 22 also has an elliptical profile, but the long and short axes defining this profile are inverted with respect to the prior art of FIG. 1A. This is best seen in FIG. 5A. The short axis is therefore aligned collinearly with the movement of the light beam 22 as described above (both along the y axis), and the long axis is aligned perpendicularly to this movement (along the x axis). The generation of a light beam having different focalisation parameters along its two axes is well known in the art and can be obtained through the use of appropriate focusing optics.

The level of focalisation of the light beam 22 along its long and short axes is dictated by the practical requirements of the targeted micro-machining application. In the current example of the cleaving of an optical fiber, it will be understood that the focalisation along the long axis must be sufficient to concentrate the laser intensity as much as possible, while not so strong as to result in a beam divergence which would preclude a straight cut. An appropriate compromise should be sought, as for example shown in FIG. 5B. Along the short axis, however, as can be seen in FIG. 5C, no compromise is necessary to ensure a straight cut as this is accomplished by the movement of the light beam 22. The beam can therefore be compressed as much as allowed by the focussing optics. This particular approach allows an intensity gain at the fiber surface by a factor of about 2 to 5 when compared to a circular light beam, and by a factor of 5 to 20 when compared to an elliptical beam aligned along the other direction as for example shown in FIG. 1A.

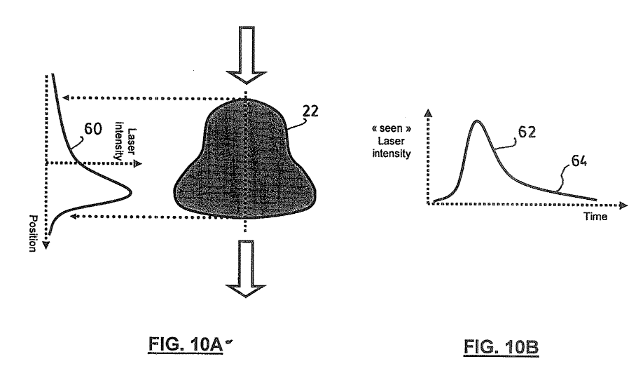

In accordance with alternative embodiments, the spatial profile of the light beam can be given a different shape, which need not be symmetrical. As will be readily understood by one skilled in the art, the spatial profile of the light beam will directly determine the temporal shape of the impulsion “seen” at each volume element of the target object. An example of a non-symmetrical spatial profile 60 is shown in FIG. 10A, and the resulting local temporal shape 62 of the light beam intersecting each volume element is shown in FIG. 10B. In this particular case, the spatial profile 60 of the light beam 22 has been designed to generate a low intensity tail 64 in the corresponding local temporal shape 62, which can be useful to reduce the thermal shock sometimes produced by exposure to a brief and intense pulse. Of course, other spatial profiles, symmetrical or otherwise, could be used depending on the circumstances and on the desired result.

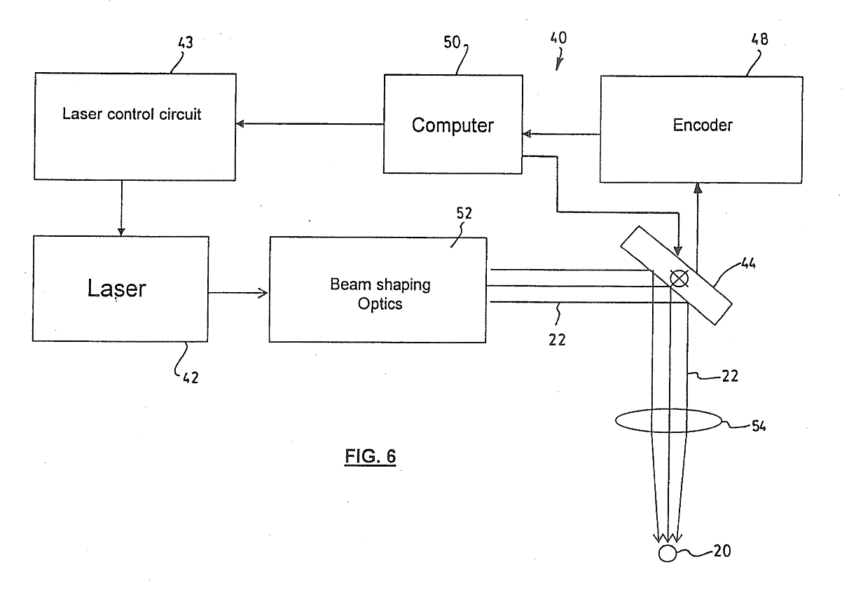

Referring now to FIG. 6, and according to another aspect of the present invention, there is provided an optical system 40 for the ablation of volume elements across a section of a target object such as an optical fiber 20.

The system 40 first includes a CO₂ laser 42, which is preferably of the type known as sealed RF-excited waveguide CO₂ lasers. The laser 42 generates a light beam 22. As explained above, the light beam 22 forms long pulses, each long pulse having a temporal shape which includes a rise time, preferably of about 50 μs to 100 μs, followed by a plateau, preferably of about 10 μs to 1000 μs. The light beam 22 has a generally constant peak power during the plateau, which can for example be of the order of 25 W to 1000 W. The laser 42 is preferably controlled by a laser control circuit 43.

The system 40 also includes moving means for moving the light beam 22 across the section of the optical fiber 20 to be ablated. In the embodiment of FIG. 6, a rotating mirror 44 is positioned in the path of the light beam 22 for this purpose. Preferably, the mirror 44 is rotated at a relatively constant speed in order to avoid having to fight its inertia. For example, a rotational speed of the order of 1000 RPM would be appropriate for a 2 inches (about 5 cm) mirror. Attainable angular speeds are advantageously greater with this approach than with a galvanometer of similar dimensions, although such a moving means could still be considered within the scope of the present invention. An appropriate support (not shown) is provided for rotating the mirror 44.

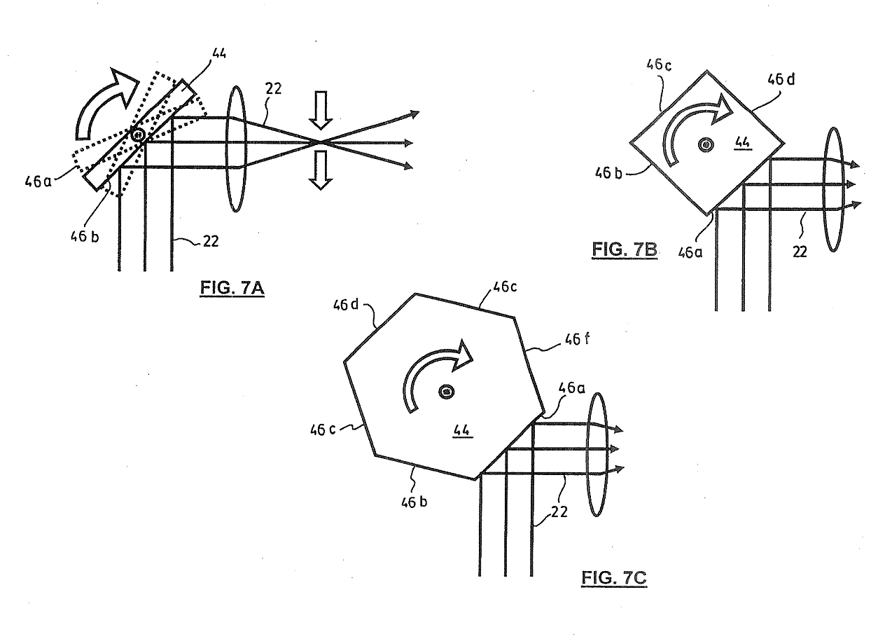

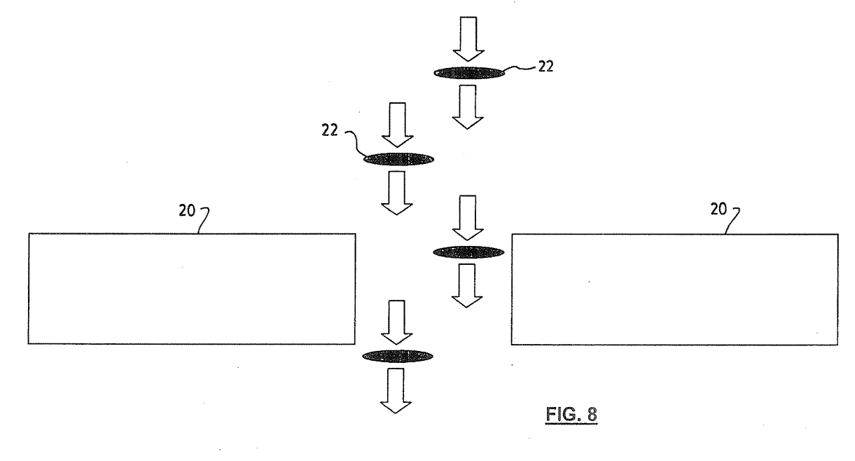

Several variants of a rotating mirror 44 are shown in FIGS. 7A to 7C. Referring particularly to FIG. 7A, it is shown how the clockwise rotation of the mirror 44 has the consequence of moving the resulting light beam 22 downward (within the plane of the page). The mirror 44 can have a single or several usable mirror faces 46a, 46b, ( . . . ), and by way of example, FIGS. 7B and 7C respectively show rotating mirrors having four and six such mirror faces 46. Increasing the number of usable mirror faces 46 has the advantage of increasing the efficiency of the ablation process using the system of the present invention. In accordance with a variant of this embodiment of the invention, different faces of a multi-face mirror could be “tilted” with respect to one another so that consecutive passages of the light beam 22 at the fiber 20 are along different optical paths intersecting different volume elements of the fiber 20. This is for example schematically illustrated in FIG. 8. This particular approach could be useful for cleaving fibers of a large size, as the light beam cuts a larger path in the fiber and can penetrate deeper within the fiber material. This approach also has the advantage of avoiding a too intense local heating of a given volume element.

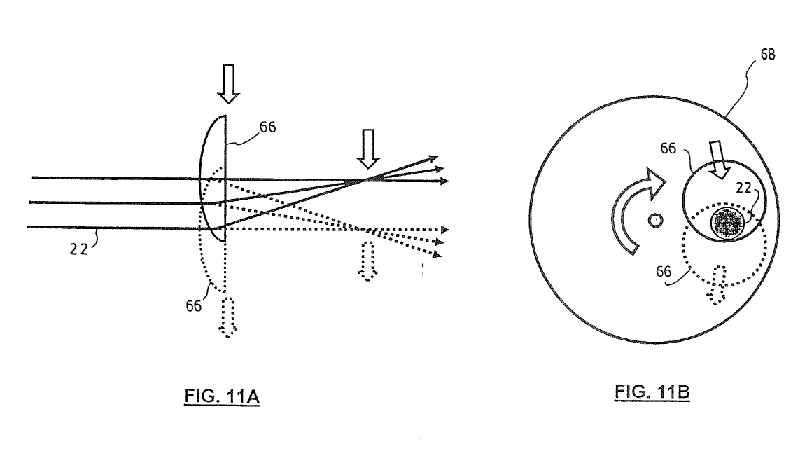

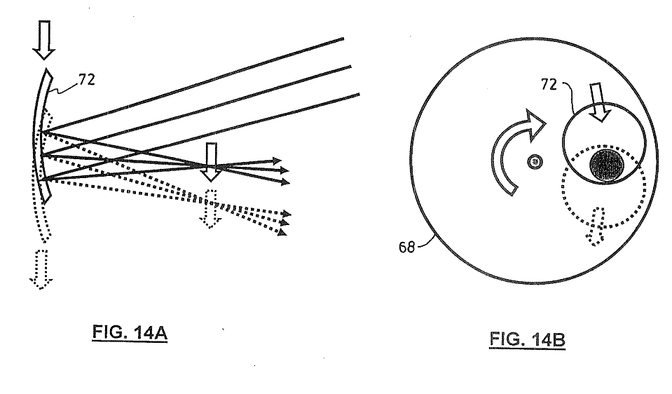

In accordance with alternative embodiments, the moving means may be embodied by moving one or several optical elements across the path of the light beam. The optical elements may be reflective, refractive or diffractive or combinations thereof. Referring to FIGS. 11A and 11B, there is shown such an embodiment where the optical element is embodied by a focussing lens 66 mounted on the surface of a rotating disk 68. The rotation of the disk 68 will bring the light beam 22 in and out of alignment with the lens 66. It will be noted that the use of such a device will give the resulting light beam projected towards the target object a slightly curved trajectory, but that for most application this curvature may be disregarded. A similar device where the lens 66 is replaced by a mirror 72 is shown in FIGS. 14A and 14B.

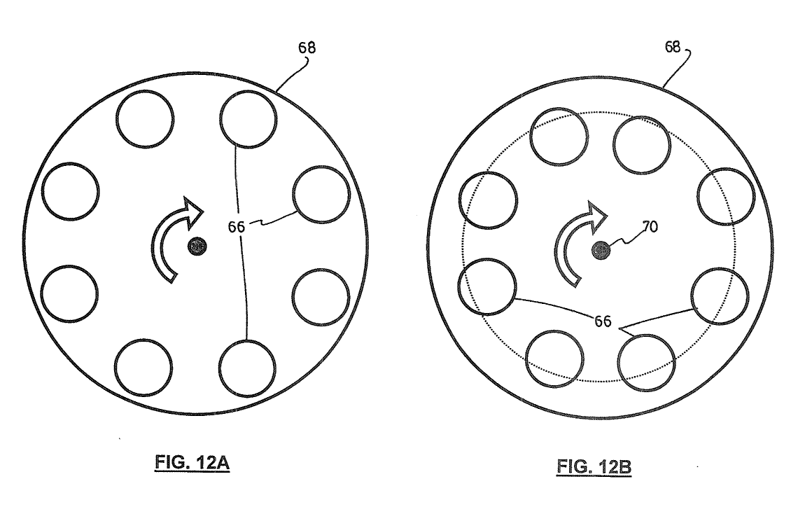

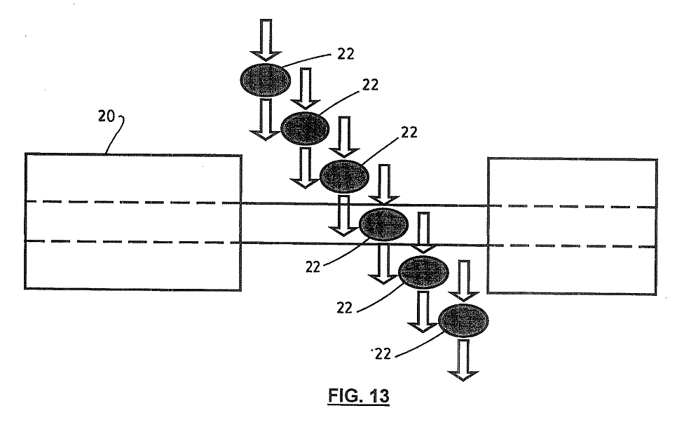

A plurality of lenses 68 or other optical elements may be mounted on a single rotating disk 68, increasing the number of passes the light beam 22 can make along the target object for each full rotation of the disk 68. Referring to FIG. 12A, there is shown such a disk where 8 lenses are mounted. It will be noted than for a large number of optical elements, such as for example 8 and up, the rotating disk 68 and lenses 66 of FIG. 12 A will generally be easier to manufacture than a multi-facet mirror according to the embodiment of FIG. 7C. Referring to FIG. 12B, I a variant of the embodiment of FIG. 12A, the lenses 66 may be mounted on the rotating disk 68 at different specific distances from the center of rotation 70 of the rotating disk 68. In this manner, the light beam may be directed along multiple trajectories so as to intersect the target object at different locations. This approach may be particularly advantageous for some ablation operations, such as for example for the striping of an optical fiber. FIG. 13 illustrates how a rotating disk of the type shown in FIG. 12B may be used to increase considerably the striping speed of an optical fiber 20 by projecting the light beam 22 along multiple trajectories.

Referring back to FIG. 6, the system 40 according to the present embodiment of the invention further includes synchronizing means for synchronizing the movement of the light beam 22 with the temporal shape of its long pulses. This synchronization is done in such a manner that the light beam 22 intersects each volume element of the section of the optical fiber 20 in synchronization with the plateau of one of the long pulses of the light beam 22, as explained above. In this manner, each volume element of the optical fiber is exposed to the peak power of the laser 42 for a short time and at least partially ablated by this exposure, while minimizing heat diffusion within the fiber. The synchronizing means preferably include an encoder 48 receiving signals from the mechanism rotating the mirror 44 or rotating disk, if provided, and a processor such as computer 50 in communication with both the laser control circuit 43 and the encoder 48. In this manner, the processor can provide control signals to synchronize the laser pulses with the rotation of the mirror 44 or other optical element and to adjust the rotation speed according to the desired processing parameters.

As will be well understood by one skilled in the art, the optical system 40 may further include any appropriate beam shaping optics 52 in the path of the optical fiber 22 as deemed required by the characteristics and geometry of a given practical embodiment of this system. In the embodiment of FIG. 6, the beam shaping optics 52 is shown to include components 52 between the laser 42 and the rotating mirror 44, as well as a lens 54 downstream the rotating mirror 44.

Preferably, the beam shaping optics is selected to shape the light beam 22 at the optical fiber 20 according to an elliptical profile defining a short axis and a long axis. As explained above, it can be advantageous to align the short axis collinearly to the direction of the moving of the light beam and the long axis perpendicularly thereto, as shown in FIG. 5A. In this configuration, the cylindrical lens 54 can focus the light beam to the diffraction limit allowed thereby without any consequence on the straightness of the cut.

It will be understood by one skilled in the art that the system and method of the present invention are not limited to making cuts at a right angle. By changing the relative angle of the light beam and the optical fiber, different cutting planes can be obtained. It is also possible to shape the extremity of the fiber along multiple planes, so as to form a two-face roof of a pyramidal shape, for example. By slowly turning the fiber on itself during the passage of the beam, a conical form can also be obtained.

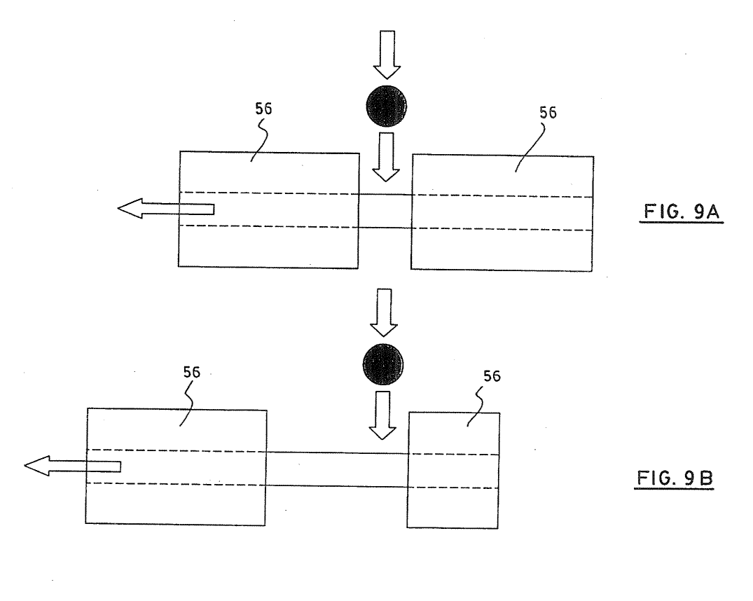

Referring to FIGS. 9A and 9B, there is shown the use of a method and system for stripping an optical fiber, that is, removing a jacket 56 thereof, according to another embodiment. This is simply accomplished by sweeping the light beam across the fiber as with the method explained above. The fiber can be move longitudinally during this operation to remove the desired portion of the jacket therealong. It will be noted that mid-span stripping were experimentally performed using the technique on SMF28 fibers and tensile strength of 400 kPSI on average were obtained.

Of course, numerous modifications could be made to the embodiments described above without departing from the scope of the present invention as defined in the appended claims.

1. A laser-based method for the ablation of volume elements across a section of a target object, the method comprising the steps of:
a) generating a light beam using a CO₂ laser, said light beam forming long pulses each having a temporal shape defined by at least a rise time and a plateau following said rise time, said light beam having a generally constant peak power during said plateau;
b) moving the light beam across said section of the target object, said moving being synchronized with the long pulses so that said light beam intersects each volume elements of said section of the target object in synchronization with the plateau of one of the long pulses of the light beam, thereby at least partially ablating said volume elements through exposition to said peak power; and
c) repeating step b) until said ablation is completed.

2. The method according to claim 1, wherein said rise time has a duration of about 50 μs to 100 μs, and said plateau has a duration of about 10 μs to 1000 μs.

3. The method according to claim 1, wherein said peak power of the long pulses is of about 25 W to 1000 W.

4. The method according to claim 1, further comprising an additional step between step a) and step b) of shaping said light beam according to an elliptical profile, said elliptical profile defining a short axis and a long axis, said additional step further comprising aligning said short and long axes of the elliptical profile of the light beam respectively collinearly and perpendicularly to a direction of the moving of step b).

5. The method according to claim 4, wherein said additional step comprises focussing said light beam to a diffraction limit allowed by focussing optics used for said focussing.

6. The method according to claim 1, further comprising an additional step between step a) and step b) of shaping said light beam according to a spatial profile selected to determine a desired local temporal shape of the light beam intersecting each of said volume elements.

7. The method according to claim 1, wherein the moving of step b) comprises providing a rotating mirror having a plurality of mirror faces in a path of said light beam.

8. The method according to claim 7, wherein said plurality of faces direct said light beam along at least two different optical paths intersecting different volume elements of said target object.

9. The method according to claim 1, wherein the moving of step b) comprises moving at least one optical element across a path of said light beam, each said at least one optical element being one of a reflective element, refractive element or diffractive element.

10. The method according to claim 9, wherein said at least one optical element consists of a plurality of lenses, each of said lenses being mounted on a rotating disk at a specific distance from a center of rotation of said rotating disk, said specific distances differing for at least two of said lenses.

11. The method according to claim 1, wherein said section of the target object is an extremity of an optical fiber.

12. The method according to claim 1, wherein said section of the target object is a portion of a cladding of an optical fiber.

13. An optical system for the ablation of volume elements across a section of a target object, the system comprising:
a CO₂ laser for generating a light beam, said light beam forming long pulses each having a temporal shape defined by at least a rise time and a plateau following said rise time, said light beam having a generally constant peak power during said plateau;
moving means for moving the light beam across said section of the target object; and
synchronizing means for synchronizing said moving with the long pulses so that said light beam intersects each volume elements of said section of the target object in synchronization with the plateau of one of the long pulses of the light beam, thereby at least partially ablating said volume elements through exposition to said peak power.

14. The optical system according to claim 13, wherein said rise time has a duration of about 50 μs to 100 μs, and said plateau has a duration of about 10 μs to 1000 μs.

15. The optical system according to claim 13, wherein said peak power of the long pulses is of about 25 W to 1000 W.

16. The optical system according to claim 13, further comprising beam shaping optics in a path of said light beam for shaping said light beam according to a spatial profile.

17. The optical system according to claim 16, wherein:
said spatial profile is an elliptical profile defining a short axis and a long axis; and
said beam shaping optics is configured to align said short and long axes of the elliptical profile of the light beam respectively collinearly and perpendicularly to a direction of the moving the light beam by the moving means.

18. The optical system according to claim 17, wherein said beam shaping optics comprise at least one cylindrical lens, said cylindrical lens focussing said light beam to a diffraction limit allowed by said beam shaping optics.

19. The optical system according to claim 16, wherein said spatial profile is selected to determine a desired local temporal shape of the light beam intersecting each of said volume elements.

20. The optical system according to claim 13, wherein said moving means comprise a rotating mirror in a path of said light beam.

21. The optical system according to claim 20, wherein said rotating mirror has a plurality of mirror faces.

22. The optical system according to claim 21, wherein said plurality of faces are oriented to direct said light beam along at least two different optical paths intersecting different volume elements of said target object.

23. The optical system according to claim 19, wherein the moving means comprises at least one optical element moving across a path of said light beam, each said at least one optical element being one of a reflective element, refractive element or diffractive element.

24. The optical system according to claim 23, wherein:
the moving means comprises a rotating disk; and
said at least one optical element consists of a plurality of lenses, each of said lenses being mounted on the rotating disk at a specific distance from a center of rotation of said rotating disk, said specific distances differing for at least two of said lenses.

25. The optical system according to claim 13, wherein said synchronizing means comprise a processor in communication with said CO₂ laser and said moving means.
